(19) United States
(12) Patent Application Publication
(10) Pub. No.: US 2025/0033074 A1
(43) Pub. Date: Jan. 30, 2025

(54) SPRAY FOAM PRESSURE DIFFERENCE CONTROL SYSTEM

(71) Applicant: Carlisle Fluid Technologies, LLC, Scottsdale, AZ (US)

(72) Inventors: Eric Donaldson, St. Paul, MN (US); Scott Powers, Oakdale, MN (US); Daniel Schmitz, Oakdale, MN (US)

(21) Appl. No.: 18/715,988

(22) PCT Filed: Dec. 28, 2022
(86) PCT No.: PCT/US2022/054166

§ 371 Date: Jun. 3, 2024

Related U.S. Application Data
(60) Provisional application No. 63/294,255, filed on Dec. 28, 2021.

(51) Int. Cl. B05B 12/00; B05B 7/16; B05B 12/08

(52) U.S. Cl. CPC B05B 12/008; B05B 7/1693; B05B 12/085

(57) ABSTRACT

The present embodiments disclose a system for maintaining a mixture temperature of a multicomponent spray while minimizing a difference in pressure between the components at an applicator, which can include at least one first component temperature sensor and at least one second component temperature sensor, at least one first component pressure sensor and at least one second component pressure sensor, at least one first component heating element, an applicator, wherein a difference in pressure between each of the multiple components is minimized by adjusting the temperature of the at least one first component; and a control system comprising an interface configured to receive at least one temperature setpoint from a user, wherein the interface is also configured to receive at least one pressure setpoint from a user.

### CROSS-REFERENCE TO RELATED APPLICATIONS

This application is a 35 U.S.C. § 371 application of international application PCT/US2022/054166, filed 28 Dec. 2022, which claims the benefit of U.S. Provisional Application Ser. No. 63/294,255, filed 28 Dec. 2021, which are incorporated as if fully rewritten herein.

### BACKGROUND

Disclosed is a spray foam pressure difference control system, and specifically, a system configured to spray multiple components to be mixed and form a mixture at a target by impingement, comprising at least one first component temperature sensor and at least one second component temperature sensor, at least one first component pressure sensor and at least one second component pressure sensor, at least one first component heating element, an applicator, wherein a difference in pressure between each of the multiple components is minimized by adjusting the temperature of the at least one first component; and a control system comprising an interface configured to receive at least one temperature setpoint from a user, wherein the interface is also configured to receive at least one pressure setpoint from a user.

In some prior art embodiments, a pressure setpoint is correlated to the pressure of either the first component or second component material at a point within that respective fluid is delivered, which can be at the fluid pump or at a point close to, or at, the spray gun. The other fluid pressure is a resultant of ratio control—e.g. the non-specified fluid pressure results from the proportioning system driving to match ratio between the two fluids. Thus, the pressures may be very different at or near the spray gun. Also, in some prior art embodiments, systems require the user to enter two separate temperature setpoints, with a resultant mixture temperature entirely resulting from ratio control.

The present embodiments can have several advantages. First, they can provide for automatic dynamic pressure balancing, which results in improved fluid mixing, more consistent pattern, and less transfer of a relatively low high pressure fluid to the line of a low pressure fluid at the applicator. Second, it can reduce the user inputs to a single temperature of the mixture at or near the gun. This reduction in setpoints avoids confusion and errors in controls.

### SUMMARY

The present embodiments disclose a system for maintaining a mixture temperature of a multicomponent spray while minimizing a difference in pressure between the components at an applicator. Disclosed is a spray foam pressure difference control system, and specifically, a system configured to spray multiple components to be mixed and form a mixture at a target by impingement, comprising at least one first component temperature sensor and at least one second component temperature sensor, at least one first component pressure sensor and at least one second component pressure sensor, at least one first component heating element, an applicator, wherein a difference in pressure between each of the multiple components is minimized by adjusting the temperature of the at least one first component; and a control system comprising an interface configured to receive at least one temperature setpoint from a user, wherein the interface is also configured to receive at least one pressure setpoint from a user.

### BRIEF DESCRIPTION OF THE FIGURES

FIG. 1 is an exemplary, non-limiting view of the embodiments described herein.

FIG. 2 is an exemplary, non-limiting cross sectional view of the component lines of the present embodiments.

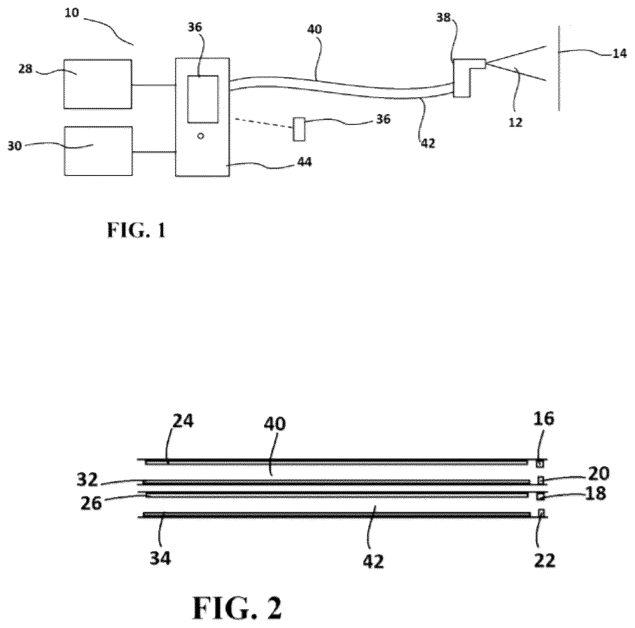

### DETAILED DESCRIPTION

Embodiments of the present invention will be described in detail below with reference to the drawings. Note that the present invention is not limited to the following description. It will be readily appreciated by those skilled in the art that modes and details of the present invention can be modified in various ways without departing from the spirit and scope of the present invention. The present invention therefore should not be construed as being limited to the following description of the embodiments. Note that in structures described below, the same portions or portions having similar functions are denoted by the same reference numerals in different drawings, and the description thereof is omitted.

In some embodiments, a system 10 configured to spray 12 multiple components to be mixed and form a mixture 12 at a target 14 by impingement, comprising at least one first component temperature sensor 16 and at least one second component temperature sensor 18; at least one first component pressure sensor 20 and at least one second component pressure sensor 22; at least one first component heating element 24; an applicator 38, wherein a difference in pressure between each of the multiple components is minimized by adjusting the temperature of the at least one first component; and a control system 44 comprising an interface 36 configured to receive at least one temperature setpoint from a user, wherein the interface 36 is also configured to receive at least one pressure setpoint from a user. In some embodiments, the control system 44 comprising a non-transitory computer readable medium containing instructions which, when executed by a processor, cause the control system 44 to perform functions of receiving a temperature setpoint from a user; receiving a pressure setpoint from the user; receiving a first component temperature signal; receiving a second component temperature signal; receiving a first component pressure signal; receiving a second component pressure signal; calculating a pressure difference; adjusting a first component temperature and a second component temperature to achieve a mixture 12 temperature corresponding to the temperature setpoint; adjusting the first component temperature and second component temperature to minimize the pressure difference between the first component and second component at an applicator 38. According to certain embodiments, the temperature setpoint corresponds to the temperature of a mixture 12 of a first component and a second component. In some embodiments, the first component temperature signal corresponds to a temperature of the first component at the applicator 38, wherein the second component temperature signal corresponds to a temperature of the second component at the applicator 38. According to certain embodiments, receiving a temperature setpoint from a user an receiving a pressure setpoint from the user occur via a graphical interface 36. In some embodiments, the graphical interface 36 is configured to be controlled by a mobile device with a wireless connection to the control system 44. According to certain embodiments, the temperature setpoint corresponds to a temperature at the applicator 38. According to certain embodiments, the temperature setpoint corresponds to a temperature of the mixture 12 of the multiple components. The temperature of the mixture 12 is calculated based on a known predetermined ratio of fluid, the first component temperature sensor 16, and second component temperature sensor 18. In some embodiments, the pressure setpoint corresponds to a pressure of the mixture 12 at the spray gun 38. In certain embodiments the pressure setpoint corresponds to the pressure of each of the multiple components at the applicator 38. The pressure and temperature sensors can be measured at the applicator 38, within the hose, or any combination thereof. When measured upstream of the applicator 38, the control system 44 can calculate a pressure and temperature corresponding to the temperature and pressure at the applicator 38 based on the position of the sensors. According to certain embodiments, the interface 36 requires only one temperature setpoint and only one pressure setpoint from the user. In some embodiments, the system 10 further comprises a first component line 40 and a second component line 42, wherein a first component line 40 is in fluid communication with a polyol source, and a second component line 42 is in fluid communication with a multi-isocyanate source or a urethane prepolymer source. According to certain embodiments, the first component line 40 and first component heating element 24 is a heated hose, and wherein the second component line 42 and second component heating element 26 is a heated hose. In some embodiments, the heating element can also include a preheater at the control system 44, which can be a proportioner configured to deliver a predetermined ratio of each component. In some embodiments, the mixture 12 reacts to form a polyurethane foam. In certain embodiments the control system 44 is configured to raise the temperature of each heated hose to achieve a minimal difference in pressure between each of the multiple components. In some embodiments, the temperature can be controlled with a cooling elements, such as a first component cooling element 32 and second component cooling element 34, wherein the cooling element can be conductive tubing with coolant, a thermoelectric cooler using the Peltier effect, or combinations thereof. In certain embodiments the applicator 38 is a spray gun 38. In some embodiments, a the at least two temperature sensing elements are selected from the group consisting of a thermal sensing element and the measured resistance of the heating element.

According to certain embodiments, a goal can be matching fluid pressures, corresponding to a first component and a second component, at the spray gun 38. This also simplifies the inputs required of the user. In this approach, the user can enter one pressure and one temperature setpoint, as opposed to entering multiple temperature and pressure setpoints. In this configuration, the dynamic pressure of each fluid can be measured at or near the spray gun 38. Due to differences in fluid viscosities the first component and second component pressures at or near the gun (or anywhere along the flow path) are generally not equal. The first component viscosities are usually temperature dependent, and not similar in their viscosities vs. temperature characteristics. By raising or lowering the fluid temperatures using first component and second component heating and cooling elements, viscosities can be adjusted to provide more equivalent pressures at or near a spray gun 38.

In some embodiments, the system 10 can automatically adjust the first component and second component temperatures to minimize pressure difference while maintaining the fluid mixture 12 temperature at the user setpoint. If the thermal properties and fluid densities are similar between the two materials, the system 10 raises the temperature of the lower pressure side and lowers the temperature of the high pressure side by equivalent amounts until the dynamic pressure difference is minimized. This can maintain the mixture 12 temperature of the fluid. If the thermal properties and/or densities of the two fluids are different, the system 10 can also adjust for those differences in the control system 44. The first component and second component temperature offsets from the user setpoint may be limited by manufacturers recommendations. The control system 44 can include instructions to not adjust temperature differences beyond user-defined recommendations.

While the above describes certain embodiments of the invention, it should be understood that the embodiments are exemplary. References in the specification to a given embodiment indicate that the embodiment described may include a particular feature, structure, or characteristic, but every embodiment may not necessarily include the particular feature, structure, or characteristic. Finally, while given components have been described separately, one of ordinary skill will appreciate that some of the components can be combined or shared in other combinations.

We claim:

1. A system configured to spray multiple components to be mixed and form a mixture at a target by impingement, comprising: at least one first component temperature sensor and at least one second component temperature sensor; at least one first component pressure sensor and at least one second component pressure sensor; at least one first component heating element; an applicator, wherein a difference in pressure between each of the multiple components is minimized by adjusting the temperature of the at least one first component; and a control system comprising an interface configured to receive at least one temperature setpoint from a user, wherein the interface is also configured to receive at least one pressure setpoint from a user.

2. The system of claim 1, wherein the temperature setpoint corresponds to a temperature at the applicator.

3. The system of claim 2, wherein the temperature setpoint corresponds to a temperature of the mixture of the multiple components.

4. The system of claim 1, wherein the pressure setpoint corresponds to a pressure at the spray gun.

5. The system of claim 4, wherein the pressure setpoint corresponds to the pressure of each of the multiple components at the applicator.

6. The system of claim 1, wherein the interface requires only one temperature setpoint and only one pressure setpoint from the user.

7. The system of claim 1, wherein the system further comprises a first component line and a second component line, wherein a first component line is in fluid communication with a polyol source, and a second component line is in fluid communication with a multi-isocyanate source or a urethane prepolymer source.

8. The system of claim 7, further comprising a second component heating element, wherein the first component line and first component heating element is a heated hose, and wherein the second component line and second component heating element is a heated hose, and wherein a difference in pressure between each of the multiple components is minimized by adjusting the temperature of the at least one second component.

9. The system of claim 8, wherein the mixture is a polyurethane foam.

10. The system of claim 9, wherein the control system is configured to raise the temperature of each heated hose to achieve a minimal difference in pressure between each of the multiple components.

11. The system of claim 1, wherein the applicator is a spray gun.

12. The system of claim 1, wherein the at least two temperature sensing elements are selected from the group consisting of a thermal sensing element and the measured resistance of the heating element.
